(19) United States
(12) Patent Application Publication
(10) Pub. No.: US 2024/0089188 A1
(43) Pub. Date: Mar. 14, 2024

(54) MONITORING SYSTEM AND MONITORING METHOD OF NETWORK LATENCY

(71) Applicant: Industrial Technology Research Institute, Hsinchu (TW)

(72) Inventors: Te-Yen Liu, Taoyuan City (TW); Chia Hung Lai, Taichung City (TW)

(73) Assignee: Industrial Technology Research Institute, Hsinchu (TW)

(21) Appl. No.: 17/978,983

(22) Filed: Nov. 2, 2022

(30) Foreign Application Priority Data
Sep. 14, 2022 (TW) 111134784

(51) Int. Cl. H04L 43/0864; H04L 43/045; H04L 43/20

(52) U.S. Cl. CPC H04L 43/0864; H04L 43/045; H04L 43/20

(57) ABSTRACT

A monitoring system and a monitoring method of network latency are provided. The monitoring method includes: making a server communicatively connect to a first host and a second host, wherein the first host provides a first virtual machine operating a first application and the second host provides a second virtual machine operating a second application; and calculating, by the server, time latency information associated with a communication between the first application and the second application according to data obtained from the first host and the second host, and displaying the time latency information through a visual interface, wherein the time latency information includes a total latency of the communication between the first application and the second application.

### CROSS-REFERENCE TO RELATED APPLICATION

This application claims the priority benefit of Taiwan application serial no. 111134784, filed on Sep. 14, 2022. The entirety of the above-mentioned patent application is hereby incorporated by reference herein and made a part of this specification.

### TECHNICAL FIELD

The disclosure relates to a monitoring system and a monitoring method of network latency.

### BACKGROUND

With the development of communication technology, the requirements for network latency are gradually increasing. For example, the ultra-reliable and low latency communications (URLLC) of the 5G communication system requires latency of 1 ms. Any abnormal event in the communication process may cause the communication delay and fail to meet user needs, resulting in reduction of user numbers or loss of revenue.

In an example of e-commerce platforms, during the highly competitive promotion period, communication delays may cause transaction failures or reduce user experience, which directly affects sales and revenue. Therefore, how to assist network administrators in accurately grasping platform performance and find out the root cause of the network latency is one of the important topics in this field.

### SUMMARY

The disclosure provides a monitoring system and a monitoring method of network latency capable of assisting a system administrator in finding out the root cause of the latency of a virtual machine system through a visual interface.

A monitoring system of network latency of the disclosure includes a server. The server is communicatively connected to a first host and a second host. The first host provides a first virtual machine operating a first application, and the second host provides a second virtual machine operating a second application. The server obtains data from the first host and the second host, calculates time latency information associated with a communication between the first application and the second application according to the data, and displays the time latency information through a visual interface. The time latency information includes total latency of the communication between the first application and the second application.

In an embodiment of the disclosure, the first application transmits a first packet to the second application at a first time point and receives a second packet corresponding to the first packet from the second application at a second time point. The total latency is equal to the latency between the second time point and the first time point.

In an embodiment of the disclosure, a first client kernel of the first virtual machine transmits the first packet to the second virtual machine at a third time point and receives an acknowledgement message corresponding to the first packet from a second client kernel of the second virtual machine at a fourth time point. The time latency information further includes a round-trip time representing latency between the fourth time point and the third time point.

In an embodiment of the disclosure, a first network interface card of the first host transmits the first packet to the second host at a fifth time point and receives a response message corresponding to the first packet from a second network interface card of the second host at a sixth time point. The time latency information further comprises physical layer latency representing latency between the sixth time point and the fifth time point.

In an embodiment of the disclosure, the time latency information further includes virtual layer latency. The server subtracts the physical layer latency from the round-trip time to calculate the virtual layer latency.

In an embodiment of the disclosure, the first client kernel of the first virtual machine receives the first packet from the first application at the third time point. The time latency information further includes first application layer latency representing latency between the third time point and the first time point.

In an embodiment of the disclosure, the first client kernel transmits the second packet from the second application to the first application at a seventh time point. The time latency information further includes second application layer latency representing latency between the second time point and the seventh time point.

In an embodiment of the disclosure, the second application receives the first packet from the first application at an eighth time point and transmits the second packet to the first application at a ninth time point. The time latency information further includes a service time representing latency between the ninth time point and the eighth time point.

In an embodiment of the disclosure, the server obtains resource utilization information from the first host and displays the resource utilization information through the visual interface.

In an embodiment of the disclosure, the resource utilization information includes at least one of the following: a CPU utilization rate of the first host, a memory utilization rate of the first host, a CPU utilization rate of the first virtual machine, a memory utilization rate of the first virtual machine, a CPU utilization rate of the first application, and a memory utilization rate of the first application.

In an embodiment of the disclosure, the monitoring system further includes the first host. The first host includes a proxy module installed in the first virtual machine. The proxy module retrieves first information from a kernel mode space of the first virtual machine and transmits the first information to the server. The server obtains the first time point, the second time point, the third time point, the fourth time point, the seventh time point, the CPU utilization rate of the first virtual machine, the memory utilization rate of the first virtual machine, the CPU utilization rate of the first application, and the memory utilization rate of the first application according to the first information.

In an embodiment of the disclosure, the monitoring system further includes the first host. The first host includes a daemon. The daemon retrieves second information from the processor of the first host and transmits the second information to the server. The server obtains the fifth time point, the sixth time point, the CPU utilization rate of the first host, and the memory utilization rate of the first host according to the second information.

In an embodiment of the disclosure, the monitoring system further includes the second host. The second host includes a proxy module installed in the second virtual machine. The proxy module retrieves third information from a kernel mode space of the second virtual machine and transmits the third information to the server, and the server obtains the eighth time point and the ninth time point according to the third information.

In an embodiment of the disclosure, the first information includes a signaling set. The server sets a first time stamp corresponding to the first signaling to the first time point in response to that the first signaling in the signaling set has a first function value and the first source port of the first signaling is greater than a default value.

In an embodiment of the disclosure, the first signaling includes a first value corresponding to a second sequence. The server selects multiple signalings from the signaling set. Each of the signalings includes a second value corresponding to a first sequence, a second function value, and a second source port greater than the default value. The first signaling in the signalings includes a third value corresponding to the second sequence. The server sets a second time stamp of the last signaling in the signalings to the second time point in response to that the third value matches the first value.

In an embodiment of the disclosure, the first information further comprises multiple acknowledgement messages. The server determines whether the acknowledgement messages include a first acknowledgement message set that matches the second value corresponding to the first sequence and sets latency of a first acknowledgement message in the first acknowledgement message set to the round-trip time in response to that the acknowledgement messages include the first acknowledgement message set.

In an embodiment of the disclosure, in response to that the acknowledgement messages include no first acknowledgement message set, the server determines whether the acknowledgement messages include a second acknowledgement message set that matches the third value corresponding to the second sequence. The server sets latency of a first acknowledgement message in the second acknowledgement message set to the round-trip time in response to that the acknowledgement messages include the second acknowledgement message set.

A monitoring method of network latency of the disclosure includes steps as follows. A server is communicatively connected to a first host and a second host. The first host provides a first virtual machine operating a first application, and the second host provides a second virtual machine operating a second application; and the server calculates time latency information associated with a communication between the first application and the second application according to data obtained from the first host and the second host and displays the time latency information through a visual interface, where the time latency information includes total latency of the communication between the first application and the second application.

In an embodiment of the disclosure, the monitoring method further includes steps as follows. A proxy module is installed in the first virtual machine. The proxy module retrieves first information from a kernel mode space of the first virtual machine and transmits the first information to the server. The server obtains a first time point and a second time point according to the first information. The first application transmits a first packet to the second application at the first time point and receives a second packet corresponding to the first packet from the second application at the second time point. The server calculates latency between the second time point and the first time point to obtain the total latency.

In an embodiment of the disclosure, the monitoring method further includes steps as follows. A daemon is installed in the first host. The daemon retrieves second information from the processor of the first host and transmits the second information to the server. The server obtains the third time point and the fourth time point according to the second information. The first network interface card of the first host transmits the first packet to the second host at the third time point and receives a response message corresponding to the first packet from the second network interface card of the second host at the fourth time point. The server calculates latency between the fourth time point and the third time point to obtain physical layer latency, where the time latency information includes the physical layer latency.

In summary, the monitoring system of the disclosure can calculate the time latency information between the host operating the virtual machine of the client and the host operating the virtual machine of the service provider and display the time latency information associated with the physical layer or the virtual layer of the virtual machine through a visual interface for the system administrator's reference.

### BRIEF DESCRIPTION OF THE DRAWING

FIG. 1 is a schematic view illustrating a monitoring system of network latency according to an embodiment of the disclosure.

FIG. 2 is a schematic view illustrating a visual interface for displaying time latency information according to an embodiment of the disclosure.

FIG. 3 is a schematic view illustrating a visual interface for displaying more detailed information according to an embodiment of the disclosure.

FIG. 4 illustrates a signaling diagram between a host and a host according to an embodiment of the disclosure.

FIG. 5 is a flowchart illustrating a monitoring method of network latency according to an embodiment of the disclosure.

### DESCRIPTION OF THE EMBODIMENTS

In order to make the content of the disclosure easier to understand, the following specific embodiments are illustrated as examples of the actual implementation of the disclosure. In addition, wherever possible, elements/components/steps with the same reference numerals in the drawings and embodiments represent the same or similar parts.

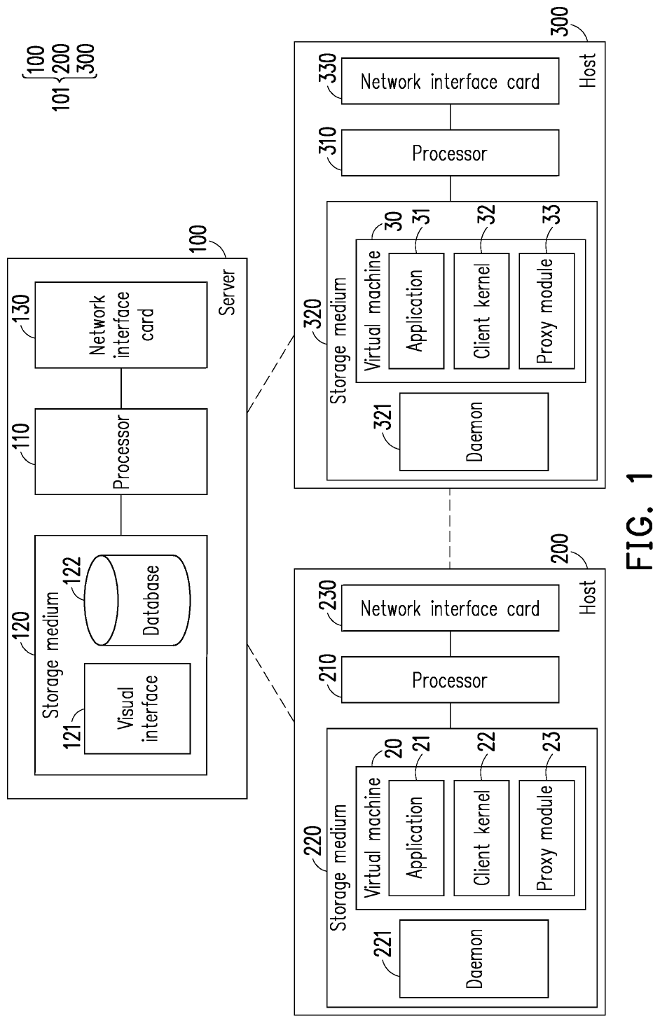

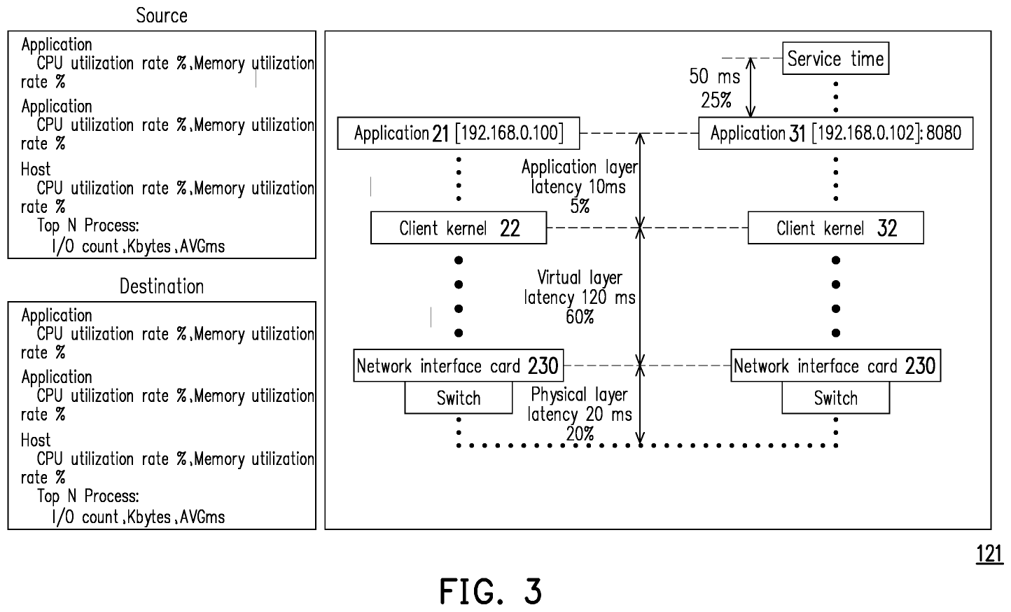

FIG. 1 is a schematic view illustrating a monitoring system 10 of network latency according to an embodiment of the disclosure. The monitoring system 10 includes at least a server 100. In one embodiment, the monitoring system 10 may further include a host 200 and a host 300. The host 200 may serve as a client, and the host 300 may serve as a service provider. The server 100, the host 200, and the host 300 are communicatively connected to each other. In one embodiment, the host 200 and the host 300 may be connected to each other for communication through one or more switches, as shown in FIG. 3. The server 100 can obtain the time latency information of the transmission between the host 200 and the host 300 and display the time latency information through a visual interface for the system administrator's reference.

The server 100 may include a processor 110, a storage medium 120, and a network interface card (NIC) 130. The host 200 may include a processor 210, a storage medium 220, and a network interface card 230. The host 300 may include a processor 310, a storage medium 320, and a network interface card 330.

The processor 110, the processor 210, or the processor 310 may include a central processing unit (CPU), or other programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA) or other similar elements, or a combination thereof. The processor 110 may be coupled to the storage medium 120 and the network interface card 130, and the processor 110 may access and execute multiple modules and various applications stored in the storage medium 120. The processor 210 may be coupled to the storage medium 220 and the network interface card 230, and the processor 210 may access and execute multiple modules and various applications stored in the storage medium 220. The processor 310 may be coupled to the storage medium 320 and the network interface card 330, and the processor 310 may access and execute multiple modules and various applications stored in the storage medium 320.

The storage medium 120, the storage medium 220, or the storage medium 320 may include any type of fixed or removable random access memory (RAM), read-only memory (ROM), flash memory, hard disk drive (HDD), solid state drive (SSD) or similar elements, or a combination thereof, and the storage medium 120, the storage medium 220, or the storage medium 320 are configured to store multiple modules or various applications that can be executed by the processor 110, the processor 210, or the processor 310. In the embodiment, the storage medium 120 may store multiple modules including a visual interface 121 and a database 122, the storage medium 220 may store multiple modules including a daemon and a virtual machine 20, etc., and the storage medium 320 may store multiple modules including a daemon and a virtual machine 30, etc. The function thereof is to be illustrated in the subsequent paragraphs.

The network interface card 130, the network interface card 230, or the network interface card 330 transmits and receives signals in a wireless or wired manner. The network interface card 130 may also perform operations, such as low noise amplification, impedance matching, frequency mixing, up or down frequency conversion, filtering, amplification, and the like.

The host 200 is configured to serve as the virtual machine 20 for a client. Multiple modules, such as an application 21, a client kernel 22, a proxy module 23, and the like can be installed in the client operating system (client OS) of the virtual machine 20 and executed by the client OS of the virtual machine 20. The host 300 is configured to serve as the virtual machine of the service provider. Multiple modules, such as an application 31, a client kernel 32, a proxy module 33, and the like can be installed in the client OS of the virtual machine 30 and can be executed by the client OS of the virtual machine 30.

The server 100 may obtain the time latency information related to the communication between the application 21 and the application 31 from the host 200 and the host 300 through the network interface card 130 and display the time latency information through the visual interface 121, and the visual interface 121 is a graphical user interface (GUI), for example. The database 122 may be configured to store time latency information obtained by the server 100 or to store any calculation results calculated by the server 100. The server 100 can locate the network device connected to the host through the media access control (MAC) address of the host, allowing the system administrator to find physical network problems in an easier manner.

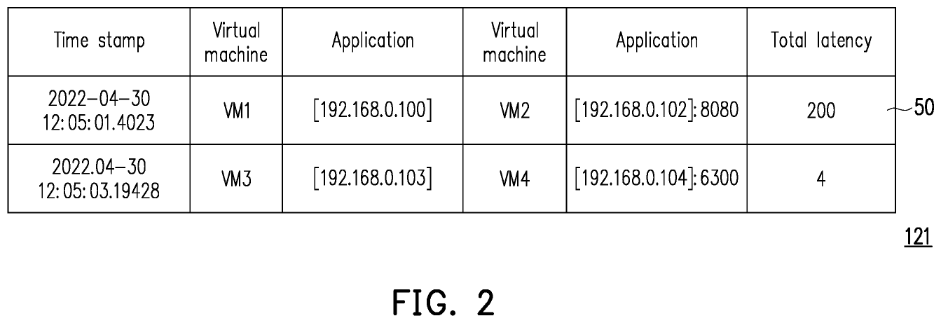

FIG. 2 is a schematic view illustrating the visual interface 121 for displaying time latency information according to an embodiment of the disclosure, and the time latency information may include total latency. The visual interface 121 displays the total latency between a virtual machine VM1 as the source (or the client) and a virtual machine VM2 as the destination (or the service provider) and displays the total latency between a virtual machine VM3 as the source and a virtual machine VM4 as destination.

The total latency field displayed on the visual interface 121 may include a hyperlink 50. After the hyperlink 50 associated with the total latency in the visual interface 121 is selected, the visual interface 121 may display more detailed information. For example, the user may select the hyperlink 50 in the visual interface 121 by operating an input device, such as a keyboard, a mouse, or a touch screen to instruct the visual interface 121 to display more detailed information related to the host 200 and the host 300.

FIG. 3 is a schematic view illustrating the visual interface 121 for displaying more detailed information according to an embodiment of the disclosure. The visual interface 121 may display the time latency information of the communication between the application 21 whose IP address is [192.168.0.100] and the application 31 whose IP address is [192.168.0.102]. Specifically, the visual interface 121 may display the physical layer latency (e.g., 20 ms) corresponding to the latency between the physical layer and the network and the corresponding percentage (e.g., 20%), virtual layer latency (e.g., 120 ms) and the corresponding percentage (e.g., 60%), application layer latency (e.g., 50 ms) and the corresponding percentage (e.g., 25%), and service time (e.g., 50 ms) and the corresponding percentage (e.g., 25%). The connection among the physical layer, the virtual layer, or the application layer can be U-shaped.

If the ratio of the latency of a certain layer is greater than a threshold, the visual interface 121 may display the connection representing the layer in an eye-catching manner (e.g., a red color is adopted to represent an alert). For example, assuming that the threshold is 50%, the visual interface 121 may display the connection in the virtual layer with a red dotted line in response to that the ratio of 60% of the virtual layer latency is greater than the threshold of 50% (e.g., the connection between the client kernel 22 and the network interface card 230, or the connection between the client kernel 32 and the network interface card 330).

In addition to displaying the time latency information of the communication between the application 21 and the application 31, the visual interface 121 can further display the resource utilization rate of the host 200 or the resource utilization rate of the host 300. The resource utilization information may include the central processing unit (CPU) utilization rate of the host 200, the memory utilization rate of the host 200, other information of host 200 (e.g., top N process, including I/O count, kilobyte count, and AVGms), the CPU utilization rate of the virtual machine 20, the memory utilization rate of the virtual machine 20, the CPU utilization rate of the application 21, and the CPU utilization rate of the application 21. The resource utilization information may further include the CPU utilization rate of the host 300, the memory utilization rate of the host 300, other information of the host 300 (e.g., top N process, including I/O count, kilobyte count, and AVGms), the CPU utilization rate of the virtual machine 30, the memory utilization rate of the virtual machine 30, the CPU utilization rate of the application 31, and the memory utilization rate of the application 31.

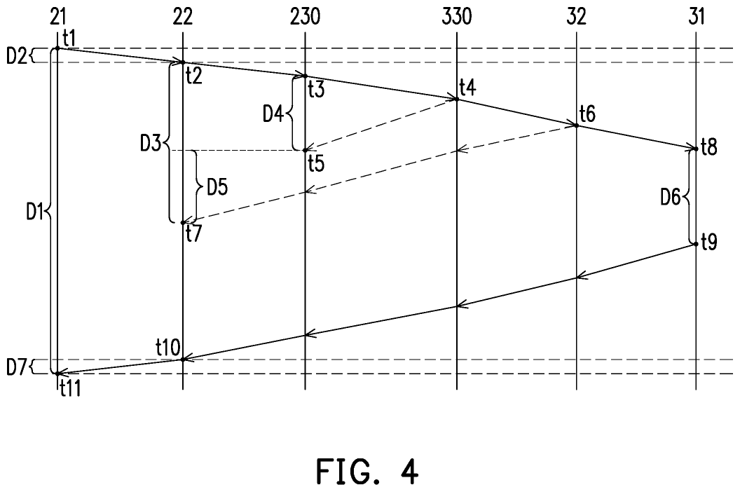

The processor 110 may calculate the time latency information displayed by the visual interface 121 according to the signaling transmitted between the application 21 and the application 31. FIG. 4 illustrates a signaling diagram between the host 200 and the host 300 according to an embodiment of the disclosure. The application 21 of the virtual machine 20 may transmit the first packet to the application 31 at a time point t1. The client kernel 22 of the virtual machine may receive the first packet from the application 21 at a time point t2 and transmit the first packet to the virtual machine 30. The network interface card 230 of the host 200 may receive the first packet at a time point t3 and transmit the first packet to the host 300. The network interface card 330 of the host 300 may receive the first packet at a time point t4 and send back a response message (e.g., a ping message) corresponding to the first packet to the network interface card 230. The network interface card 230 may receive the response message from the network interface card 330 at a time point t5.

In addition, the network interface card 330 may transmit the first packet to the client kernel 32 of the virtual machine 30 at the time point t4. The client kernel 32 may receive the first packet from the client kernel 32 at a time point t6 and transmit an acknowledgement (ACK or tcp_ACK) message corresponding to the first packet to the client kernel 22. The client kernel 22 may receive the acknowledgement message from the client kernel 32 at a time point t7.

On the other hand, the client kernel 32 may transmit the first packet to the application 31 of the virtual machine 30 at the time point t6. The application 31 may receive the first packet from the client kernel 32 at a time point t8 and transmit a second packet corresponding to the first packet to the application 21 at a time t9. The client kernel 22 may receive the second packet from the application 31 at a time point t10 and transmit the second packet to the application 21. The application 21 may receive the second packet from the application 31 (or the client kernel 22) at a time point t11.

In one embodiment, the processor 110 may calculate the total latency between the application 21 and the application 31 according to the time point t1 and the time point t11, and the total latency may be equal to latency D1 between the time point t11 and the time point t1. The first packet or the second packet is a transmission control protocol (TCP) packet, for example. For example, the first packet is transmitted through the kernel function tcp_sendmsg( ) and the second packet is received through the kernel function tcp_recvmsg( )

In one embodiment, the processor 110 may calculate latency D2 between the time point t2 and the time point t1 according to the time point t1 and the time point t2, and the latency D2 may correspond to the application layer latency. The processor 110 may utilize the kernel function skb_copy_datagram_iter( ) or the kernel function tcp_transmit_skb( ) to calculate the time (i.e., the latency D2) it takes the data packet to be transmitted from the application 21 to the client kernel 22.

In one embodiment, the processor 110 may calculate latency D7 between the time point t11 and the time point t10 according to the time point t10 and the time point t11, and the latency D7 may correspond to the application layer latency. The processor 110 may utilize the kernel function skb_copy_datagram_iter( ) or the kernel function tcp_transmit_skb( ) to calculate the time (i.e., the latency D7) it takes for the data packet to be transmitted from the client kernel 22 to the application 21.

In one embodiment, the processor 110 may calculate the latency D3 between the time point t7 and the time point t2 according to the time point t2 and the time point t7, and the latency D3 is the round-trip time (RTT) of the client kernel 22.

In one embodiment, the processor 110 may calculate the latency D4 between the time point t5 and the time point t3 according to the time point t3 and the time point t5, and the latency D4 may represent the physical layer latency. “20 ms” as shown in FIG. 3 is an example of the physical layer latency. The processor 110 may subtract the physical layer latency (i.e., the latency D4) from the RTT (i.e., the latency D3) to calculate the latency D5, and the latency D5 may represent the virtual layer latency. “120 ms” as shown in FIG. 3 is an example of the virtual layer latency.

In one embodiment, the processor 110 may calculate the latency D6 between the time point t9 and the time point t8 according to the time point t8 and the time point t9, and the latency D6 may represent the service time of the application 31. In one embodiment, the processor 110 may calculate the latency D6 according to the latency D1, the latency D2, the latency D3, and the latency D7 as expressed by Equation (1).

D6=D1-D2-D3-D7 (1)

In one embodiment, the processor 110 may calculate the latency D7 between the time point t11 and the time point t10 according to the time point t10 and the time point t11, and the latency D7 may correspond to the application layer latency. “10 ms” as shown in FIG. 3 is an example of the application layer latency, and the application layer latency is equal to the sum of the latency D2 and the latency D7.

In one embodiment, the proxy module 23 installed in the virtual machine 20 can retrieve information from the kernel mode space of the virtual machine 20 and transmit the information to the server 100. The server 100 can obtain the time point t1, the time point t2, the time point t7, the time point t11, the CPU utilization rate of the virtual machine 20, the memory utilization rate of the virtual machine 20, the CPU utilization rate of the application 21, or the memory utilization rate of the application 21 from the information.

In one embodiment, a daemon 221 may retrieve information from the processor 210 of the host 200 and transmit the information to the server 100. The server 100 may obtain the time point t3, the time point t5, the CPU utilization rate of the host 200 or the memory utilization rate of the host 200 from the information. In one embodiment, the information retrieved by the daemon 221 may further include the MAC address or device name of the network device connected to the host 200, source port (SPORT), destination port (DPORT), the first sequence (SEQ), the second sequence (SEQ2), temp SEQ, acknowledgement sequence (ACK SEQ) or time stamp, and the second sequence is also called a copied SEQ.

In one embodiment, the proxy module 33 installed in the virtual machine 30 can retrieve information from the kernel mode space of the virtual machine 30 and transmit the information to the server 100. The server 100 can obtain the time point t6, the time point t8, the time point t9, the CPU utilization rate of the virtual machine 30, the memory utilization rate of the virtual machine 30, the CPU utilization rate of the application 31, or the memory utilization rate of the application 31.

In one embodiment, a daemon 321 may retrieve information from the processor 310 of the host and transmit the information to the server 100. The server 100 may obtain the time point t4, the CPU utilization rate of the host 300, or the memory utilization rate of the host 300 from the information. In one embodiment, the information may further include the MAC address or device name of the network device connected to the host 300.

In one embodiment, the proxy module 23 (or the proxy module 33) may be implemented by extended Berkeley packet filter (eBPF) technology. Therefore, the proxy module 23 (or the proxy module 33) requires no modification of the kernel mode of the virtual machine 20 (or the virtual machine 30) nor loading of the kernel module. That is, a custom bytecode in the kernel is executed to obtain information from the kernel mode space of the virtual machine, and the kernel mode space is, for example, a host OS kernel.

In one embodiment, the information retrieved by the proxy module 23 from the kernel mode space of the virtual machine 20 may include a signaling set. The processor 110 may obtain the time point t1 according to the signaling in the signaling set. Specifically, if the first signaling in the signaling set has a function value and the source port of the first signaling is greater than a default value, the processor 110 may determine that the first signaling is sent by the client, and the source of the first signaling is the client, where the default value can be “32768”, and the function value can be “1”. Accordingly, the processor 110 may set the time stamp of the first signaling to the time point t1.

Table 1 is an example of signaling in the signaling set. The signaling may include information, such as time stamp, function (FDNC), source port (SPORT), first sequence (SEQ), or second sequence (SEQ2), and the second sequence is also called the copied SEQ. In one embodiment, the signaling may further include a process identifier (PID), a thread identifier (TID), a parent process identifier (PPID), a command (COMM), a source address (SADDR), a destination address (DADDR), or a destination port (DPORT), and the like. The processor 110 may set the time stamp T1 of the signaling #1 to the time point t1 in response to that the signaling #1 has the function value “1” and the source port “43528” of the signaling #1 being greater than the default value “32768”. In the embodiment, the function value “1” represents the kernel function tcp_sendmsg( ) and the function value “2” represents the kernel function tcp_recvmsg( ).

TABLE 1

| Index | Time stamp | FUNC | SPORT | SEQ | SEQ2 |
|---|---|---|---|---|---|
| #1 | T1 | 1 | 43528 | 5958 | 6655 |
| #2 | T2 | 2 | 43528 | 6036 | 6655 |
| #3 | T3 | 2 | 43528 | 6036 | 9687 |
| #4 | T4 | 2 | 43528 | 6036 | 1135 |

On the other hand, the processor 110 may obtain the time point t11 according to the signaling in the signaling set. Specifically, it is assumed that the first signaling includes a value corresponding to the second sequence (SEQ2). The processor 110 may select multiple signalings from the signaling set. Each of the selected signalings may include the same information, such as a value corresponding to the first sequence (SEQ), a function value, and a source port greater than a default value, where the default value may be “32768”, and the function value may be “2”. Furthermore, the first signaling of the signalings may include a value corresponding to the second sequence (SEQ2). The processor 110 may set the time stamp of the last signaling in the signalings to the time point t11 in response to that the value corresponding to the second sequence included in the first signaling matches the value corresponding to the second sequence included in the first signaling (i.e., the two values are the same).

Taking Table 1 as an example, the processor 110 selects multiple signalings from the signaling set, including a signaling #2, a signaling #3, and a signaling #4. Each of the signaling selected by the processor 110 includes a function value “2”, a value “6036” corresponding to the SEQ, and a source port “43528” greater than the default value “32768”. The first signaling in the signalings is the signaling #2, and the last signaling is the signaling #4. The processor 110 may set a time stamp T4 of signaling #4 to the time point t11 in response to that the value “6655” corresponding to SEQ2 included in the signaling #1 matches the value “6655” corresponding to the SEQ2 included in the signaling #2.

In one embodiment, the information retrieved by the proxy module 23 from the kernel mode space of the virtual machine 20 may include multiple acknowledgement messages. The processor 110 may obtain the round-trip time according to multiple acknowledgement messages. Specifically, the processor 110 may determine whether the acknowledgement messages include a first acknowledgement message set that matches the values of the first sequence corresponding to the signalings. If the acknowledgement messages include the first acknowledgement message set, the processor 110 may set the latency of the first acknowledgement message in the first acknowledgement message set to the round-trip time.

Table 2 is an example of multiple acknowledgement messages. The acknowledgement message may include information, such as the virtual machine that transmits the acknowledgement message, the first sequence (SEQ), the acknowledgement message sequence (ACK SEQ), the latency, and the like. Referring to Table 1 and Table 2, the processor 110 may determine that the acknowledgement message sequence “6036” of the acknowledgement message #2 and the acknowledgement message #3 in the multiple acknowledgement messages matches the first sequence “6036” of the signaling #2 (or the signaling #3 and the signaling #4), and it is determined that the acknowledgement message #2, the acknowledgement message #3, and the acknowledgement message #4 may form the first acknowledgement message set. Accordingly, the processor 110 may set the latency “388 ms” of the first acknowledgement message (i.e., the acknowledgement message #2) in the first acknowledgement message set to the round-trip time (i.e., the latency D3).

TABLE 2

| Index | Virtual machine | SEQ | ACK_SEQ | Latency (ms) |
|---|---|---|---|---|
| #1 | VM2 | 6654 | 5958 | 395 |
| #2 | VM2 | 6655 | 6036 | 388 |
| #3 | VM2 | 8103 | 6036 | 388 |
| #4 | VM2 | 2447 | 6036 | 388 |

On the other hand, if the acknowledgement messages include no first acknowledgement message set, the processor 110 may determine whether the acknowledgement messages include a second acknowledgement message set that matches the value of the second sequence corresponding to the first signaling. If the acknowledgement messages include the second acknowledgement message set, the processor 110 may set the latency of the first acknowledgement message in the second acknowledgement message set to the round-trip time.

Table 3 is an example of multiple acknowledgement messages. Referring to Table 1 and Table 3, the processor 110 may determine that the acknowledgement messages in Table 2 do not include the first acknowledgement message set that matches the first sequence “6036” of the signaling #2 (or the signaling #3 and the signaling #4), and it is further determined whether the acknowledgement messages include acknowledgement messages that matches the second sequence “6655” of the signaling #2. Since the acknowledgement message sequence “6655” of the acknowledgement message #2, the acknowledgement message #3, and the acknowledgement message #4 of Table 3 matches the second sequence “6655” of the signaling #2, the processor 110 may determine that the acknowledgement message #2, the acknowledgement message #3, and the acknowledgement message #4 may form the second acknowledgement message set. Accordingly, the processor 110 may set the latency “388 ms” of the first acknowledgement message (i.e., the acknowledgement message #2) in the second acknowledgement message set to the round-trip time (i.e., the latency D3).

TABLE 3

| Index | Virtual machine | SEQ | ACK_SEQ | Latency (ms) |
|---|---|---|---|---|
| #1 | VM2 | 6654 | 5958 | 395 |
| #2 | VM2 | 8239 | 6655 | 388 |
| #3 | VM2 | 8103 | 6655 | 388 |
| #4 | VM2 | 2447 | 6655 | 388 |

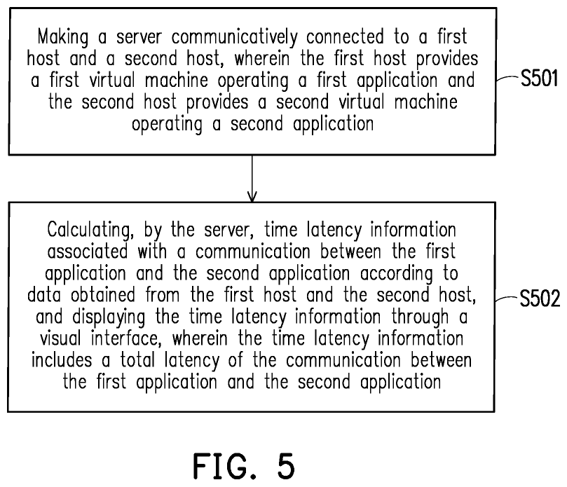

FIG. 5 is a flowchart illustrating a monitoring method of network latency according to an embodiment of the disclosure. The monitoring method can be implemented by the monitoring system 10 shown in FIG. 1. In step S501, the server is communicatively connected to the first host and the second host, the first host provides the first virtual machine operating the first application, and the second host provides the second virtual machine operating the second application. In step S502, the server obtains data from the first host and the second host, calculates the time latency information associated with the communication between the first application and the second application according to the data, and displays the time latency information through a visual interface. The time latency information includes the total latency of the communication between the first application and the second application.

In summary, the monitoring system of the disclosure can obtain transmission information from the host operating the virtual machine of the client and the host operating the virtual machine of the service provider. The monitoring system can calculate the latency between the two hosts according to the transmission information and display the latency information across the physical layer and the virtual layer through a visual interface, so as to assist the system administrator in quickly identifying that the abnormal event that causes the latency occurs in the physical layer or in the virtual layer.

1. A monitoring system of network latency, comprising:
a server communicatively connected to a first host and a second host, wherein the first host provides a first virtual machine operating a first application, and the second host provides a second virtual machine operating a second application, wherein
the server obtains data from the first host and the second host, calculates time latency information associated with a communication between the first application and the second application according to the data, and displays the time latency information through a visual interface, wherein the time latency information comprises total latency of the communication between the first application and the second application, wherein
the first host comprises a first proxy module installed in the first virtual machine and the first proxy module receives first information from a kernel mode space of the first virtual machine and transmits the first information to the server, wherein the first information comprises a signaling set, wherein
the server sets a first time stamp corresponding to a first signaling as a first time point in response to that the first signaling in the signaling set has a first function value and a first source port of the first signaling is greater than a default value.

2. The monitoring system of network latency of claim 1, wherein the first application transmits a first packet to the second application at the first time point and receives a second packet corresponding to the first packet from the second application at a second time point, wherein the total latency is equal to the latency between the second time point and the first time point.

3. The monitoring system of network latency of claim 2, wherein a first client kernel of the first virtual machine transmits the first packet to the second virtual machine at a third time point and receives an acknowledgement message corresponding to the first packet from a second client kernel of the second virtual machine at a fourth time point, wherein the time latency information further comprises a round-trip time representing latency between the fourth time point and the third time point.

4. The monitoring system of network latency of claim 3, wherein a first network interface card of the first host transmits the first packet to the second host at a fifth time point and receives a response message corresponding to the first packet from a second network interface card of the second host at a sixth time point, wherein the time latency information further comprises physical layer latency representing latency between the sixth time point and the fifth time point.

5. The monitoring system of network latency of claim 4, wherein the time latency information further comprises virtual layer latency, wherein the server subtracts the physical layer latency from the round-trip time to calculate the virtual layer latency.

6. The monitoring system of network latency of claim 5, wherein the first client kernel of the first virtual machine receives the first packet from the first application at the third time point, wherein the time latency information further comprises first application layer latency representing latency between the third time point and the first time point.

7. The monitoring system of network latency of claim 6, wherein the first client kernel transmits the second packet from the second application to the first application at a seventh time point, wherein the time latency information further comprises second application layer latency representing latency between the second time point and the seventh time point.

8. The monitoring system of network latency of claim 7, wherein the second application receives the first packet from the first application at an eighth time point and transmits the second packet to the first application at a ninth time point, wherein the time latency information further comprises a service time representing latency between the ninth time point and the eighth time point.

9. The monitoring system of network latency of claim 1, wherein the server obtains resource utilization information from the first host and displays the resource utilization information through the visual interface.

10. The monitoring system of network latency of claim 9, wherein the resource utilization information comprises at least one of the following: a CPU utilization rate of the first host, a memory utilization rate of the first host, a CPU utilization rate of the first virtual machine, a memory utilization rate of the first virtual machine, a CPU utilization rate of the first application, and a memory utilization rate of the first application.

11. The monitoring system of network latency of claim 8,
wherein the server obtains the first time point, the second time point, the third time point, the fourth time point, the seventh time point, the CPU utilization rate of the first virtual machine, the memory utilization rate of the first virtual machine, the CPU utilization rate of the first application, and the memory utilization rate of the first application according to the first information.

12. The monitoring system of network latency of claim 11, wherein
the first host further comprises a daemon, wherein the daemon retrieves second information from a processor of the first host and transmits the second information to the server, wherein the server obtains the fifth time point, the sixth time point, the CPU utilization rate of the first host, and the memory utilization rate of the first host according to the second information.

13. The monitoring system of network latency of claim 11, further comprising:
the second host comprising a second proxy module installed in the second virtual machine, wherein the second proxy module retrieves third information from a kernel mode space of the second virtual machine and transmits the third information to the server, and the server obtains the eighth time point and the ninth time point according to the third information.

14. (canceled)

15. The monitoring system of network latency of claim 11, wherein the first signaling comprises a first value corresponding to a second sequence, wherein the server selects a plurality of signalings from the signaling set, wherein each of the plurality of signalings comprises a second value corresponding to a first sequence, a second function value, and a second source port greater than the default value, and a first of the plurality of signalings comprises a third value corresponding to the second sequence, wherein the server sets a second time stamp of a last of the plurality of signalings as the second time point in response to that the third value matches the first value.

16. The monitoring system of network latency of claim 15, the first information further comprises a plurality of acknowledgement messages, wherein the server determines whether the plurality of acknowledgement messages comprise a first acknowledgement message set that matches the second value corresponding to the first sequence and sets latency of a first acknowledgement message in the first acknowledgement message set to the round-trip time in response to that the plurality of acknowledgement messages comprise the first acknowledgement message set.

17. The monitoring system of network latency of claim 16, wherein in response to that the plurality of acknowledgement messages comprise no first acknowledgement message set, the server determines whether the plurality of acknowledgement messages comprise a second acknowledgement message set that matches the third value corresponding to the second sequence, wherein the server sets latency of a first acknowledgement message in the second acknowledgement message set to the round-trip time in response to that the plurality of acknowledgement messages comprise the second acknowledgement message set.

18. A monitoring method of network latency, comprising:
making a server communicatively connected to a first host and a second host, wherein the first host provides a first virtual machine operating a first application, and the second host provides a second virtual machine operating a second application;
calculating time latency information associated with a communication between the first application and the second application according to data obtained from the first host and the second host by the server, and displaying the time latency information through a visual interface, wherein the time latency information comprising total latency of the communication between the first application and the second application;
installing a first proxy module in the first virtual machine;
receiving first information from a kernel mode space of the first virtual machine by the first proxy module and transmitting the first information to the server, wherein the first information comprises a signaling set; and
setting a first time stamp corresponding to the first signaling as a first time point by the server in response to that the first signaling in the signaling set has a first function and a first source port of the first signaling is greater than a default value.

19. The monitoring method of network latency of claim 18, further comprising:
obtaining the first time point and a second time point by the server according to the first information, wherein the first application transmits a first packet to the second application at the first time point and receives a second packet corresponding to the first packet from the second application at the second time point; and
calculating latency between the second time point and the first time point by the server to obtain the total latency.

20. The monitoring method of network latency of claim 19, further comprising:
installing a daemon in the first host;
retrieving, by the daemon, second information from a processor of the first host and transmitting the second information to the server;
obtaining the third time point and the fourth time point by the server according to the second information, wherein a first network interface card of the first host transmits the first packet to the second host at the third time point and receives a response message corresponding to the first packet from a second network interface card of the second host at the fourth time point; and
calculating latency between the fourth time point and the third time point by the server to obtain physical layer latency, wherein the time latency information comprises the physical layer latency.
